(19) United States
(12) Patent Application Publication
(10) Pub. No.: US 2022/0335183 A1
(43) Pub. Date: Oct. 20, 2022

(54) SIMULATION DEVICE, LEARNING DEVICE, SIMULATION METHOD, AND SIMULATION PROGRAM

(71) Applicant: NIPPON TELEGRAPH AND TELEPHONE CORPORATION, Tokyo (JP)

(72) Inventors: Koshin TO, Tokyo (JP); Akira NAKAYAMA, Tokyo (JP); Masaru MIYAMOTO, Tokyo (JP); Shinya OI, Tokyo (JP); Yusuke TANAKA, Tokyo (JP); Takayuki ADACHI, Tokyo (JP); Mitsutoshi NAGAHAMA, Tokyo (JP); Maiko NAYA, Tokyo (JP)

(73) Assignee: NIPPON TELEGRAPH AND TELEPHONE CORPORATION, Tokyo (JP)

(21) Appl. No.: 17/763,473

(22) PCT Filed: Oct. 2, 2019
(86) PCT No.: PCT/JP2019/038931

§ 371 Date: Mar. 24, 2022

(51) Int. Cl. G06F 30/27; G06F 30/17

(52) U.S. Cl. CPC G06F 30/27; G06F 30/17

(57) ABSTRACT

A vector field setting unit (102) sets a vector field for providing virtual force for reproducing, in a region in which a moving body moves, movement of the moving body in a certain direction, and a simulation unit (104) simulates the movement of the moving body in the region, based on a movement model to which a parameter for simulating the movement of the moving body is set and the vector field set by the vector field setting unit, whereby the movement of the moving body is appropriately simulated even when the movement of the moving body is unusual.

### TECHNICAL FIELD

The disclosed techniques relate to a simulation apparatus, a learning apparatus, a simulation method, and a simulation program.

### BACKGROUND ART

There have been attempts to predict a flow of human in the future (after a time point T) and reproduce a flow of human in the past, based on data obtained by measuring the number of people passing through a plurality of monitoring points and the number of people within a monitoring area.

For example, techniques using LONG SHORT-TERM MEMORY (LSTM), Markov chain (NPL 1 and 2), and the like have been proposed for predicting a flow of human.

Furthermore, there is a technique of setting a walk model for a movement (walking) of people, and simulating the movement of people assuming that the people moves along the walk model. For example, a walk model has been proposed using, as parameters, acceleration force toward ideal speed, repulsion from environments such as walls, and attraction force from others, objects, and the like (NPL 3).

Furthermore, a technique has been proposed for simulating movement of a target object (such as human), with the target object moving to an adjacent cell or staying where he or she is under a predetermined rule within each area segmented by cells (NPL 4).

### CITATION LIST

### Non Patent Literature

NPL 1: S. Hochreiter, et al. “LONG SHORT-TERM MEMORY”, Neural computation 9.8, (1997), p. 1735 to 1780.
NPL 2: C. J. Geyer, “Practical Markov Chain Monte Carlo”, Statistical science vol. 7 No. 4, (1992), p. 473 to 483.
NPL 3: D. Helbing, P. Molnar, “Social force model for pedestrian dynamics”, Physical Review E 51, (1995), p. 4282 to 4286.
NPL 4: K. Nagel, M. Schreckenberg, “A cellular automaton model for freeway traffic”, Journal de Physique I, EDP Sciences, (1992), p. 2221 to 2229.

### SUMMARY OF THE INVENTION

### Technical Problem

Some related-art techniques take interaction between pedestrians into consideration, but are incapable of reproducing an unusual movement of human, such as that in a case where the flow of human is controlled under a crowded condition, for example.

The disclosed technique has been made in view of the above, and an object of the present invention is to appropriately simulate movement of a moving body even when the movement of the moving body is unusual.

### Means for Solving the Problem

A first aspect of the present disclosure relates to a simulation apparatus including: a vector field setting unit configured to set a vector field for providing virtual force for reproducing, in a region in which a moving body moves, movement of the moving body in a certain direction; and a simulation unit configured to simulate the movement of the moving body in the region, based on a movement model to which a parameter for simulating the movement of the moving body is set and the vector field set by the vector field setting unit.

A second aspect of the present disclosure relates to a learning apparatus including a learning unit configured to learn, based on monitoring data at a plurality of past time points at which movement of a moving body has been monitored, a vector field used for reproducing movement of the moving body in a region in which the moving body moves, together with a movement model to which a parameter for simulating the movement of the moving body is set, the vector field providing virtual force for simulating movement of the moving body in a certain direction.

A third aspect of the present disclosure relates to a simulation method executed by a simulation apparatus including a vector field setting unit and a simulation unit, the method including: setting, at the vector field setting unit, a vector field for providing virtual force for reproducing, in a region in which a moving body moves, movement of the moving body in a certain direction; and simulating, at the simulation unit, the movement of the moving body in the region, based on a movement model to which a parameter for simulating the movement of the moving body is set and the vector field set by the vector field setting unit.

A fourth aspect of the present disclosure relates to a simulation program causing a computer to function as: a vector field setting unit configured to set a vector field for providing virtual force for reproducing, in a region in which a moving body moves, movement of the moving body in a certain direction; and a simulation unit configured to simulate the movement of the moving body in the region, based on a movement model to which a parameter for simulating the movement of the moving body is set and the vector field set by the vector field setting unit.

### Effects of the Invention

According to the disclosed technology, movement of the moving body can be appropriately simulated even when the movement of the moving body is unusual.

### BRIEF DESCRIPTION OF DRAWINGS

FIG. 1 is a block diagram illustrating a hardware configuration of a simulation apparatus.

FIG. 2 is a block diagram illustrating an example of functional components of the simulation apparatus.

FIG. 3 is a schematic diagram illustrating a difference in movement of a moving body between a normal condition and a crowded condition.

FIG. 4 is a schematic diagram illustrating movement of people for getting on and off a train.

FIG. 5 is a schematic diagram illustrating an example of a vector field.

FIG. 6 is a schematic diagram illustrating an example of a vector field.

FIG. 7 is a diagram illustrating an example of parameters of a movement model.

FIG. 8 is a flowchart illustrating a sequence of a learning process.

FIG. 9 is a flowchart illustrating a sequence of a simulation process.

### DESCRIPTION OF EMBODIMENTS

Hereinafter, one example of the embodiments of the disclosed technique will be described with reference to the drawings. In the drawings, the same reference numerals are given to the same or equivalent constituent elements and parts. The dimensional ratios in the drawings are exaggerated for convenience of explanation and may differ from the actual ratios.

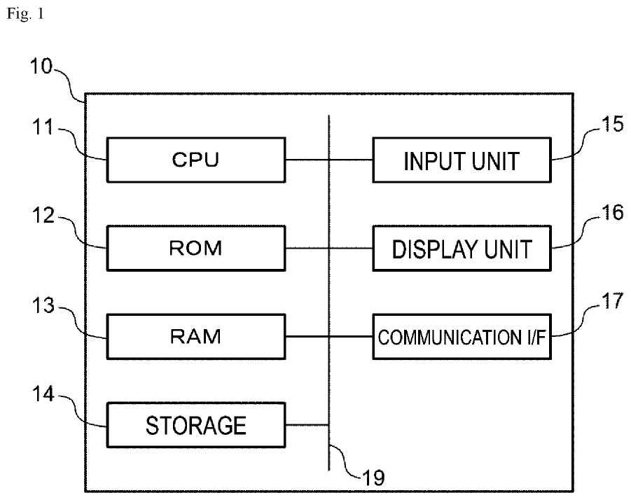

FIG. 1 is a block diagram illustrating a hardware configuration of a simulation apparatus 10.

As illustrated in FIG. 1, the simulation apparatus 10 includes a central processing unit (CPU) 11, a read only memory (ROM) 12, a random access memory (RAM) 13, a storage 14, an input unit 15, a display unit 16, and a communication interface (I/F) 17. The components are communicably interconnected through a bus 19.

The CPU 11 is a central processing unit that executes various programs and controls each unit. In other words, the CPU 11 reads a program from the ROM 12 or the storage 14 and executes the program using the RAM 13 as a work area. The CPU 11 performs control of each of the components described above and various arithmetic processing operations in accordance with a program stored in the ROM 12 or the storage 14. In the present embodiment, a simulation program for executing a learning process and a simulation process described below is stored in the ROM 12 or the storage 14.

The ROM 12 stores various programs and various kinds of data. The RAM 13 is a work area that temporarily stores a program or data. The storage 14 is constituted by a storage device such as a hard disk drive (HDD) or a solid state drive (SSD) and stores various programs including an operating system and various kinds of data.

The input unit 15 includes a pointing device such as a mouse and a keyboard and is used for performing various inputs.

The display unit 16 is, for example, a liquid crystal display and displays various kinds of information. The display unit 16 may employ a touch panel system and function as the input unit 15.

The communication I/F 17 is an interface for communicating with other devices and, for example, uses a standard such as Ethernet (trade name), FDDI, or Wi-Fi (trade name).

Next, functional components of the simulation apparatus 10 will be described.

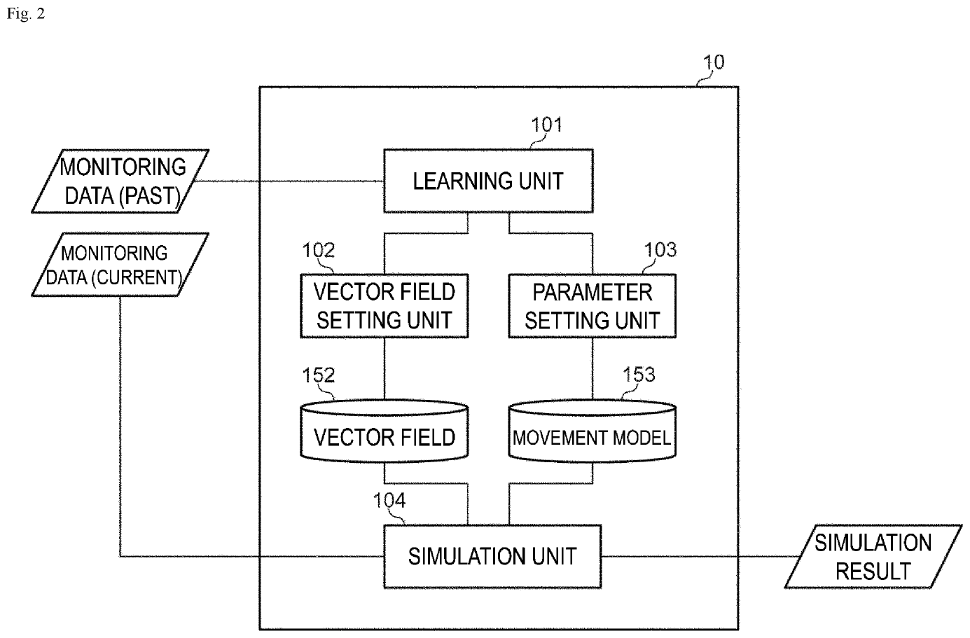

FIG. 2 is a block diagram illustrating an example of functional components of the simulation apparatus 10.

As illustrated in FIG. 2, the simulation apparatus 10 includes a learning unit 101, a vector field setting unit 102, a parameter setting unit 103, and a simulation unit 104 as functional components. A vector field 152 and a movement model 153 for simulating movement of a moving body are stored in a predetermined storage region of the simulation apparatus 10. Each functional component is realized by the CPU 11 reading the simulation program stored in the ROM 12 or the storage 14 and loading and executing the simulation program onto and in the RAM 13.

The learning unit 101 receives an input of monitoring data (hereinafter, referred to as “monitoring data (past)”) at a plurality of time points in the past at which movement of the moving body has been monitored. Note that, when a learning process is performed in real-time, the input of monitoring data at the current time point (hereinafter, referred to as “monitoring data (current)”) may also be received.

The monitoring data at each time point is, for example, data that can be used to simulate the movement of the moving body, such as the number of the moving bodies passing through a plurality of points and the number of moving bodies in an area, at the time point. The monitoring data is acquired based on, for example, sensor data detected by various sensors and images captured by a camera. The monitoring data may be manually monitored data obtained by using a number detector or the like.

Based on the received monitoring data (past), the learning unit 101 learns the vector field 152 providing virtual force to reproduce movement of the moving body in a certain direction in a region where the moving body moves.

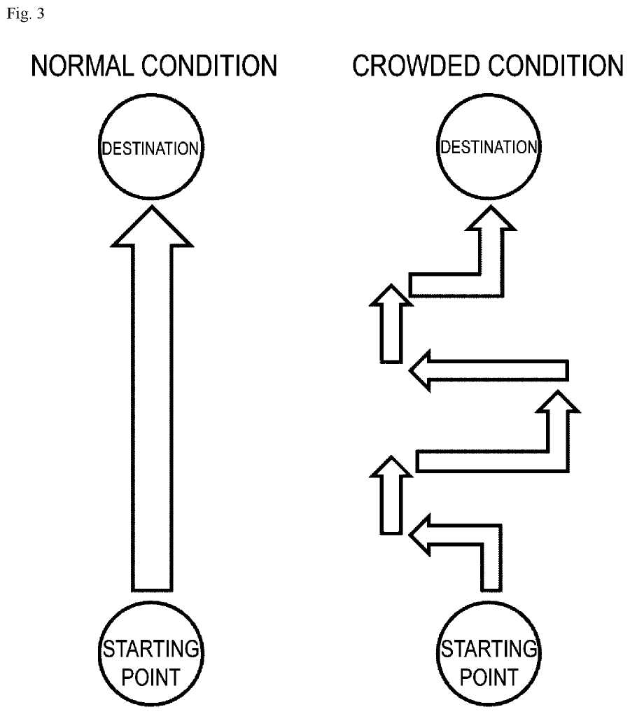

For example, as illustrated in FIG. 3, under a normal condition, the moving body moves along the shortest path from the starting point to the destination. On the other hand, under a crowded condition, the movement path is controlled, resulting in a meandering route or the like, and the moving body moves in accordance with this movement path control. If the movement of the moving body expected by the movement model 153 is the movement under the normal condition as described above, appropriate simulation results cannot be obtained when the simulation is performed using the movement model 153 under the crowded condition.

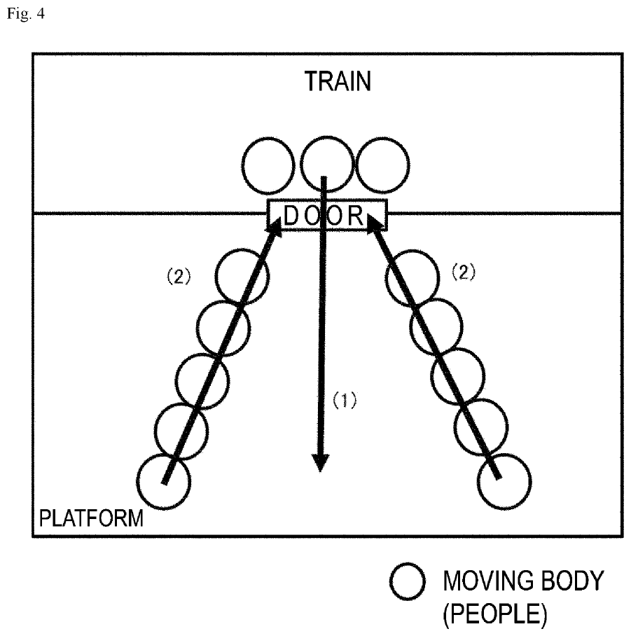

The movement of people for getting on and off a train as illustrated in FIG. 4 occurs with (1) passengers in the train getting off, and then (2) people on the platform getting on the train. Such a flow might fail to be reproduced with the movement model 153 alone.

In view of this, in the present embodiment, the vector field 152 is set separately from the movement model 153, and the movement of the moving body is simulated based on the movement model 153 and the vector field 152.

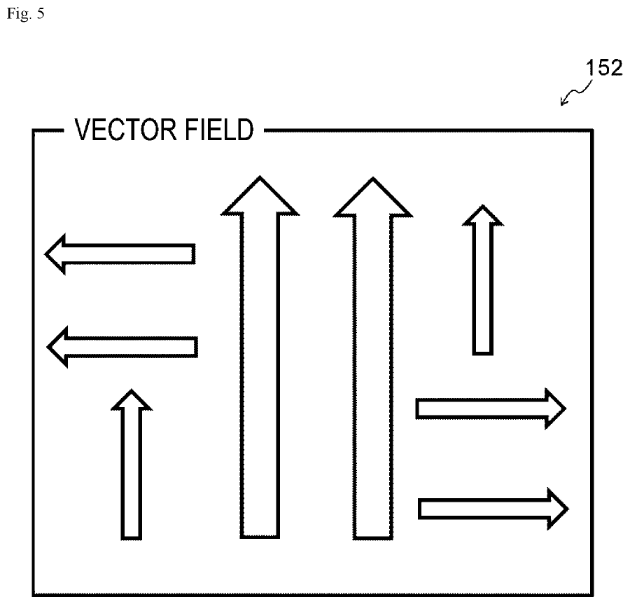

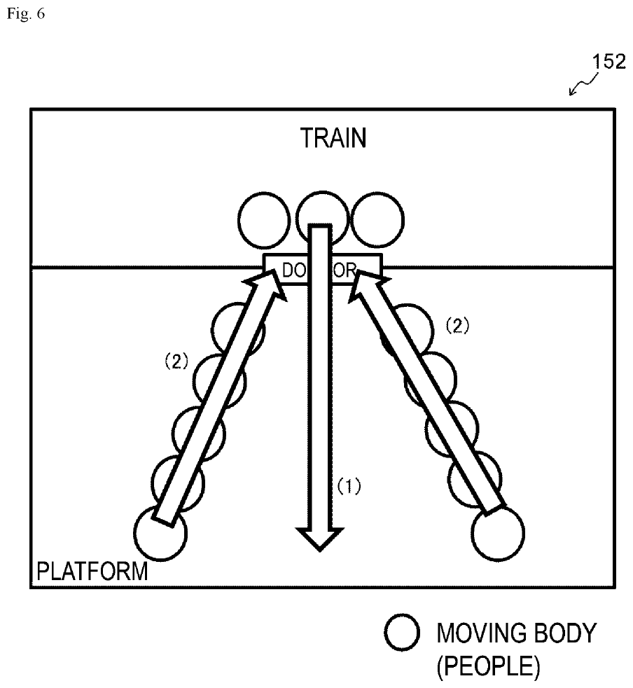

Specifically, as illustrated in FIG. 5, a vector field indicating a force causing the movement of the moving body in a certain direction in the region in which the moving body moves is generated in association with at least one of a location within the region and a time point of the simulation. In the case of the example illustrated in FIG. 4, the vector field is generated in such a manner that, as illustrated in FIG. 6, the vector field generates forces ((1) and (2)) with the force (1) produced first and then the force (2) produced with a time difference.

More specifically, a case is assumed in which the learning unit 101 receives the input of the monitoring data (past) at time points T1, T2, . . . , and TN. In this case, for example, the learning unit 101 sets the initial position and the number of moving bodies based on the monitoring data at a time point T1, and moves each moving body thus set in accordance with the parameter of the movement model 153, to predict movement of the moving body at the time points T2, . . . , and TN. The learning unit 101 generates a vector field to approximate the movement direction of the moving body indicated by the prediction result to the movement direction of the moving body indicated by the monitoring data (past) at the time points T2, . . . , and TN.

Furthermore, the learning unit 101 learns the parameters of the movement model 153 so that the actual movement can be more appropriately reproduced with the movement model 153.

The movement model 153 is a model for simulating movement of the moving body. An existing model such as that described in NPLs 3 and 4 can be used as the movement model 153. For example, the parameters set to the movement model 153 for simulating the movement of the moving body include acceleration force toward ideal speed, repulsion from environments such as walls, and attraction force from others, objects, and the like.

Specifically, the learning unit 101 learns the parameters of the movement model 153, for at least one of the moving body, relationship between the moving body and another moving body, and relationship between the moving body and the surrounding environment (such as a wall) of the moving body, in association with at least one of the location where the moving body exists and the time point of the simulation.

Specifically, the learning unit 101 learns the acceleration for the ideal speed of the moving body, which is a parameter of the movement model 153, based on the actual movement of the moving body. Furthermore, the learning unit 101 learns the magnitude of attraction force or repulsion between the moving bodies and/or between the moving body and the surrounding environment of the moving body, which is a parameter of the movement model 153, based on the actual movement of the moving body.

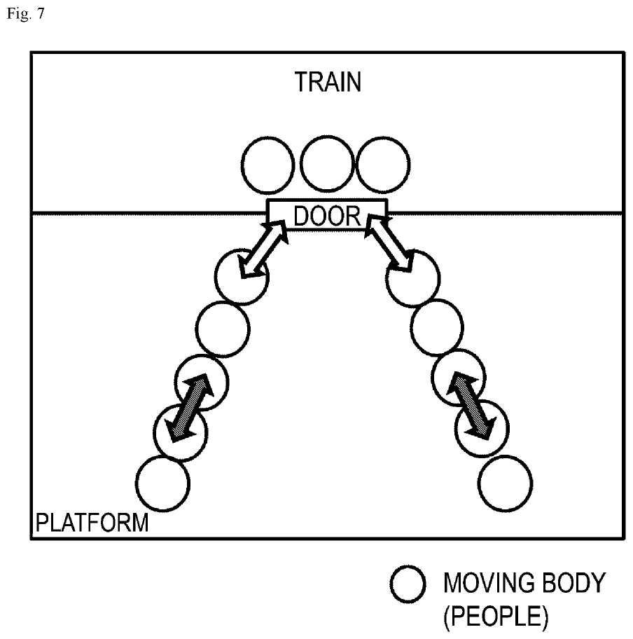

For example, as illustrated in FIG. 7, the learning unit 101 learns the parameters so that the repulsion between a person and a door increases to prevent a person on a platform from getting on the train until the door opens and people getting off the train passes through the person (white block arrow in FIG. 7). Furthermore, in order to reproduce how the people wait in line on the platform, the learning unit 101 learns the parameters to set large attraction force between people on the platform (hatched block arrow in FIG. 7). The specific learning method may be implemented through comparison between the monitoring data (past) and a prediction result obtained by the simulation based on the movement model 153, as in the case of the learning of the vector field 152 as described above.

The learning unit 101 passes the learned vector field 152 to the vector field setting unit 102. The learning unit 101 passes the learned parameter of the movement model 153 to the parameter setting unit 103.

The vector field setting unit 102 sets the vector field 152 received from the learning unit 101 to be usable together with the movement model 153 in the simulation unit 104 described below, and stores the resultant vector field 152 in a predetermined storage region. As a result, the vector field is set in association with at least one of the location in the region where the moving body moves and the time point of the simulation.

The parameter setting unit 103 sets the parameter received from the learning unit 101 to the movement model 153, and stores the resultant movement model 153 in a predetermined storage region. As a result, at least one of the acceleration for the ideal speed of the moving body, the attraction force or the repulsion between the moving bodies, and the attraction force or the repulsion between the moving body and the surrounding environment of the moving body is set to be the parameter of the movement model 153 in association with at least one of the location where the moving body exists and the time point of the simulation.

The simulation unit 104 simulates movement of the moving body in the region, based on the vector field 152 set by the vector field setting unit 102 and the movement model 153 the parameters of which have been set by the parameter setting unit 103.

Specifically, the simulation unit 104 receives the input of the monitoring data (current), and sets the initial position and number of moving bodies based on the received monitoring data (current). The simulation unit 104 moves each moving body thus set, in accordance with the parameter of the movement model 153 and the vector field 152 to perform simulation to predict movement of the moving body at a future time point or reproduce the movement of the moving body at a time point in the past. Thus, the moving direction and speed of the moving body are determined based on the interaction between the movement model 153 and the vector field 152, so that a simulation result appropriately reproducing the actual movement of the moving body can be obtained. The simulation unit 104 outputs the simulation result.

Next, an operation of the simulation apparatus 10 will be described.

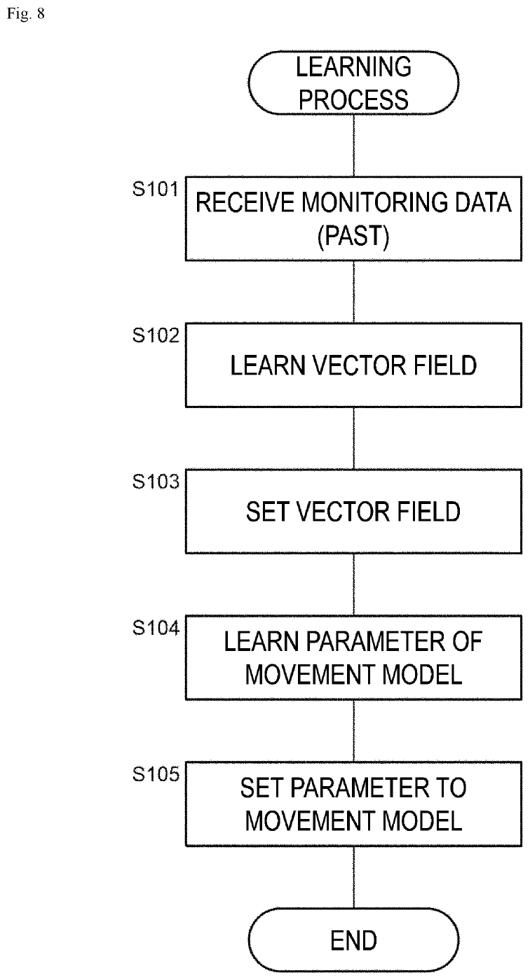

FIG. 8 is a flowchart illustrating a sequence of the learning process performed by the simulation apparatus 10. The CPU 11 reads the simulation program from the ROM 12 or the storage 14, loads the simulation program onto the RAM 13, and executes the simulation program, to perform the learning process.

In step S101, the CPU 11 serves as the learning unit 101 and receives monitoring data (past) input to the simulation apparatus 10.

Next, in step S102, the CPU 11 serves as the learning unit 101, and based on the received monitoring data (past), the learning unit 101 learns the vector field 152 providing virtual force to reproduce movement of the moving body in a certain direction in a region where the moving body moves. Then, the CPU 11 serves as the learning unit 101, and passes the learned vector field 152 to the vector field setting unit 102.

Next, in step S103, the CPU 11 serves as the vector field setting unit 102, and sets the vector field 152 received from the learning unit 101 to be usable together with the movement model 153 in the simulation unit 104, and stores the resultant vector field 152 in a predetermined storage region.

Next, in step S104, the CPU 11 serves as the learning unit 101, and learns the parameters of the movement model 153 so that the actual movement can be more appropriately reproduced with the movement model 153. The CPU 11 serves as the learning unit 101, and passes the learned parameter of the movement model 153 to the parameter setting unit 103.

Next, in step S105, the CPU 11 serves as the parameter setting unit 103, and sets the parameter received from the learning unit 101 to the movement model 153, and stores the resultant movement model 153 in a predetermined storage region. Then, the learning process ends.

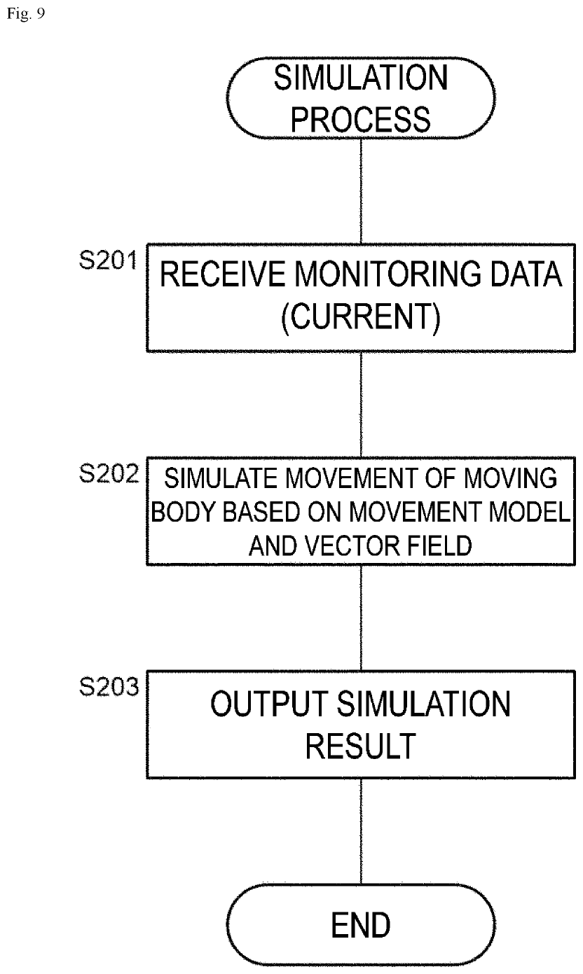

FIG. 9 is a flowchart illustrating a sequence of the simulation process performed by the simulation apparatus 10. The CPU 11 reads the simulation program from the ROM 12 or the storage 14, loads the simulation program onto the RAM 13, and executes the simulation program, to perform the simulation process.

In step S201, the CPU 11 serves as the simulation unit 104 and receives monitoring data (current) input to the simulation apparatus 10.

Next, in step S202, the CPU 11 serves as the simulation unit 104 and sets the initial position and number of the moving bodies based on the received monitoring data (current). Then, the CPU 11 serves as the simulation unit 104, and moves the moving body thus set, based on the parameter of the movement model 153 and the vector field 152. As a result, simulation predicting the movement of the moving body at a future time point, or reproducing movement of the moving body at a past time point is implemented.

Next, in step S203, the CPU 11 serves as the simulation unit 104, and outputs the simulation result, and then simulation process ends.

As described above, with the simulation apparatus according to the present embodiment, virtual force for reproducing the movement of the moving body in a certain direction at each location and time point is set as the vector field, based on monitoring data (past). The simulation apparatus then uses the set vector field together with the movement model to simulate the movement of the moving body. This allows the simulation apparatus to appropriately simulate the movement of the moving body even in cases where movement of the moving body is unusual, such as movement under the movement control in a case where people wait in line or the like.

Furthermore, the simulation apparatus variably sets the parameter of the movement model for each location and time point based on the monitoring data (past), so that the movement of the moving body can be more accurately simulated.

Note that in the above embodiment, a description is given on a case in which the learning unit learns the vector field and the parameters of the movement model. Alternatively, the vector field and the parameters of the movement model may be manually set.

Furthermore, in the embodiment described above, a case is described in which both the vector field and the parameters of the movement model are set. Alternatively, at least the vector field may be set, and a model in which an existing parameter is set may be used for the movement model.

Further, in the above embodiment, the configuration is described in which the simulation apparatus also includes the learning unit. Alternatively, the learning unit may be configured as a learning apparatus separate from the simulation apparatus.

Note that the simulation process which is performed by causing the CPU to read and execute the software (program) in the above-described embodiment may be performed by various processors other than the CPU. Examples of the processor in such a case include a programmable logic device (PLD) such as a field-programmable gate array (FPGA) the circuit configuration of which can be changed after manufacturing, a dedicated electric circuit such as an application specific integrated circuit (ASIC) that is a processor having a circuit configuration designed dedicatedly for executing the specific processing, and the like. Further, the simulation process may be performed by one of these various processors or a combination of two or more processors of the same type or different types (such as, for example, a combination of a plurality of FPGAs and a combination of a CPU and an FPGA). More specifically, the hardware structure of such various processors is an electrical circuit obtained by combining circuit devices such as semiconductor devices.

In each of the embodiment described above, although a form in which the simulation program is stored (installed) in the ROM 12 or the storage 14 in advance has been described, the form is not limited thereto. The program may be provided in the form of being stored in a non-transitory storage medium such as a compact disc read only memory (CD-ROM), a digital versatile disc read only memory (DVD-ROM), a Blu-ray disc, or a universal serial bus (USB) memory. The program may be in a form that is downloaded from an external apparatus via a network.

Relating to the embodiment described above, the following supplementary notes are disclosed.

Supplementary Note 1

A simulation apparatus comprising:
a memory; and
at least one processor connected to the memory,
the processor being configured to:
set a vector field for providing virtual force for reproducing, in a region in which a moving body moves, movement of the moving body in a certain direction; and
simulate the movement of the moving body in the region, based on a movement model to which a parameter for simulating the movement of the moving body is set and the vector field set by the vector field setting unit.

Supplementary Note 2

A non-transitory recording medium storing a program executable by a computer to execute a simulation process, the simulation process comprising:
setting a vector field for providing virtual force for reproducing, in a region in which a moving body moves, movement of the moving body in a certain direction; and
simulating the movement of the moving body in the region, based on a movement model to which a parameter for simulating the movement of the moving body is set and the vector field set by the vector field setting unit.

### REFERENCE SIGNS LIST

10 Simulation apparatus
11 CPU
12 ROM
13 RAM
14 Storage
15 Input unit
16 Display unit
17 Communication I/F
19 Bus
101 Learning unit
102 Vector field setting unit
103 Parameter setting unit
104 Simulation unit
152 Vector field
153 Movement model

1. A simulation apparatus comprising a circuit configured to execute a method comprising:
setting a vector field for providing virtual force for reproducing, in a region in which a moving body moves, movement of the moving body in a direction; and
simulating the movement of the moving body in the region, based on a movement model to which a parameter for simulating the movement of the moving body is set and the vector field.

2. The simulation apparatus according to claim 1, wherein the vector field is associated with at least one of a location in the region and a time point of the simulating.

3. The simulation apparatus according to claim 1, the circuit further configured to execute a method comprising:
setting the parameter of the movement model.

4. The simulation apparatus according to claim 3, wherein the parameter is at least based on, for at least one of:
the moving body,
relationship between the moving body and another moving body, or
relationship between the moving body and a surrounding environment of the moving body, and
wherein the parameter is associated with at least one of a location where the moving body exists and a time point of the simulating.

5. The simulation apparatus according to claim 3, the circuit further configured to execute a method comprising:
learning at least one of the vector field and the parameter, based on monitoring data at a plurality of past time points at which the movement of the moving body has been monitored.

6. A learning apparatus comprising a circuit configured to execute a method comprising:
learning, based on monitoring data at a plurality of past time points at which movement of a moving body has been monitored, a vector field used for reproducing the movement of the moving body in a region in which the moving body moves, together with a movement model to which a parameter for simulating the movement of the moving body is set, the vector field providing virtual force for simulating the movement of the moving body in a certain direction.

7. A computer-implemented method for simulating, the method comprising:
setting, a vector field for providing virtual force for reproducing, in a region in which a moving body moves, movement of the moving body in a certain direction; and
simulating, the movement of the moving body in the region, based on a movement model to which a parameter for simulating the movement of the moving body is set and the vector field.

8. (canceled)

9. The simulation apparatus according to claim 2, the circuit further configured to execute a method comprising:
setting the parameter of the movement model.

10. The simulation apparatus according to claim 4, the circuit further configured to execute a method comprising:
learning at least one of the vector field and the parameter, based on monitoring data at a plurality of past time points at which the movement of the moving body has been monitored.

11. The learning apparatus according to claim 6, wherein the vector field is associated with at least one of a location in the region and a time point of the simulating.

12. The learning apparatus according to claim 6, the circuit further configured to execute a method comprising:
setting the parameter of the movement model.

13. The learning apparatus according to claim 11, the circuit further configured to execute a method comprising:
setting the parameter of the movement model.

14. The learning apparatus according to claim 12, wherein the parameter is at least based on, for at least one of:
the moving body,
relationship between the moving body and another moving body, or
relationship between the moving body and a surrounding environment of the moving body, and
wherein the parameter is associated with at least one of a location where the moving body exists and a time point of the simulating.

15. The learning apparatus according to claim 12, the circuit further configured to execute a method comprising:
learning at least one of the vector field and the parameter, based on monitoring data at a plurality of past time points at which the movement of the moving body has been monitored.

16. The learning apparatus according to claim 14, the circuit further configured to execute a method comprising:
learning at least one of the vector field and the parameter, based on monitoring data at a plurality of past time points at which the movement of the moving body has been monitored.

17. The computer-implemented method according to claim 7, wherein the vector field is associated with at least one of a location in the region and a time point of the simulating.

18. The computer-implemented method according to claim 7, the method further comprising:
setting the parameter of the movement model.

19. The computer-implemented method according to claim 17, the method further comprising:
setting the parameter of the movement model.

20. The computer-implemented method according to claim 18, wherein the parameter is at least based on, for at least one of:
the moving body,
relationship between the moving body and another moving body, or
relationship between the moving body and a surrounding environment of the moving body, and
wherein the parameter is associated with at least one of a location where the moving body exists and a time point of the simulating.

21. The computer-implemented method according to claim 18, the method further comprising:
learning at least one of the vector field and the parameter, based on monitoring data at a plurality of past time points at which the movement of the moving body has been monitored.
